(19) United States
(12) Patent Application Publication
(10) Pub. No.: US 2018/0225985 A1
(43) Pub. Date: Aug. 9, 2018

(54) OPERATOR READINESS TESTING AND TRACKING SYSTEM

(71) Applicant: Dusan Damjanovic, Lewisburg, PA (US)

(72) Inventor: Dusan Damjanovic, Lewisburg, PA (US)

(21) Appl. No.: 15/426,001

(22) Filed: Feb. 6, 2017

(51) Int. Cl. G09B 19/00

(52) U.S. Cl. CPC G09B 19/00

(57) ABSTRACT

An operator readiness testing and tracking system tests operator-readiness in situations in which the operator must perform in a highly reliable manner. The system is preferably embodied in a portable slate-computer or tablet-computer having a touch responsive screen which tests visual, audio, and motor control pathways as well as basic level of cognitive ability. The system provides a number of tests designed to provide physiological responses to sound and light stimuli, and responses to cognitive testing. Data collected for each operator tested is stored in a historical database to provide baseline information for current testing in the event of a decline in operator performance.

### CROSS-REFERENCE TO RELATED APPLICATION

This application claims the benefit of U.S. Provisional Patent Application 62/388,551 filed Feb. 6, 2016 by the applicant herein and entitled “Operator Readiness Testing And Tracking System”, the disclosure of which is incorporated herein by reference.

### BACKGROUND

Various occupations and tasks require high-skilled operators to perform their tasks with the requisite skill level and with a minimum risk of an undesired outcome. Operators of various types of aircraft and various types of ground vehicles are expected to perform their duties without accident or misadventure. In a similar manner, members of the medical profession, such as surgeons, are required to perform surgical tasks in a low-risk manner.

Unfortunately, operator readiness cannot be assumed in view of fatigue-inducing work hours, inadequate sleep history, short- or long-term emotional issues, use of alcohol, and/or the use of both legal and illegal drugs.

An impaired operator is a significant safety risk in a number of industries, especially medicine, transportation (airlines, railways, shipping, etc), nuclear engineering and many other industries and vocations that an operator to be ready to perform their assigned tasks. There is always the possibility that an impaired operator will not be able to adequately perform the intended task leading to a lapse in safety and as well as a loss of life and/or property.

For certain occupations, it is important to test for adequate operator readiness for the task at hand. Ideally, that test should measure the readiness of various neural pathways (i.e., visual, aural, and motor response) and cognitive ability in a relatively short period of time (a few minutes) to assess for deterioration with respect to the test history of that operator and the test history of other operators in the particular occupation. Thus, an airline pilot, a train operator, a surgeon, a truck driver, etc., can be tested in a relatively short period of time and the test performance compared with prior test results for that individual and for other individuals in that occupation. Thus, in the case of an airline pilot, that pilot's test results can be compared to prior tests result for that pilot and for all pilots employed by that employer.

The need to recognize readiness deterioration before it becomes a safety event can be achieved through continuous or near-continuous readiness testing. In order to maximize the benefit of readiness testing, that testing must be simple, accurate, and take a relatively short period of time to accomplish.

### SUMMARY

A readiness-testing system includes a computer-controlled display with touch-screen and/or voice input capability for presenting the test-subject with various visual stimuli, audio speakers for presenting the test-subject with instructions and/or audio stimuli.

At one level, visual and/or audio cues are presented to the test-subject. The computer includes one or more cameras and associated facial recognition and pupil/facial features tracking software that recognizes the test-subject's facial features and pupil movement in response to stimuli. The test-subject can be asked to focus on a portion of the display, be subjected to a short-duration light pulse (i.e., flash or blink of light), with the facial recognition camera and associated software determining if the subject moves to look in the direction of the light pulse with the associated time-duration of that movement (which includes pupil movement) are stored in a database.

At a cognitive level in which the visual pathway and the motor skill pathway is engaged, the test-subject can be presented with a sequence of randomly chosen numbers or alpha characters appearing on the display with the requirement that those numbers and/or alpha characters be inputted into a touch-screen keyboard (or a physical keyboard) in the sequential order in which they appeared on the display. The accuracy of the keypress sequence, the accuracy of the character keypresses, the time-to-complete each keypress, and the time-to-complete the test are stored in a database. This test can be repeated n times to create a data set in which the statistical mean can function as a figure of merit. Additionally, each successive test can be provided with instruction to complete the task within a selected time, i.e., 10-seconds, 9-seconds, 8-seconds, 7-seconds, 6-seconds, etc. in order to find the best time for that test-subject following the same testing protocol.

At a further cognitive level, the test-subject can be presented via a visual display and or via audio instruction with an arithmetic problem for which the solution thereof is entered via a touchscreen keyboard or spoken into a microphone with both the solution and the time-to-completion for that solution being stored in the database.

Depending upon the tests and sub-tests used, the test-subject's audio processing pathway, visual processing pathway, motor control pathways, and cognitive performance can be determined and compared with that test-subjects prior results to determine whether there has been a deterioration in the test-subjects readiness for performing the required occupational task. Additionally, the test-subjects results for that test can be compared to a group-average for all test-subjects in that occupation.

The device, preferably the size a slate- or tablet-computer, is mounted at the entry point into the area of operation, for example, at the door of an operating room in a hospital, at the door of the cockpit of an airplane, the cabin of a locomotive, etc. and be activated either by the fingerprint, iris scan, or some other unique biometric identifier.

Once activated, the series of quick tests is performed by the operator, testing the nervous system responsiveness and executive function ability. The whole test including sub-tests, should take a short amount of time, to be determined by the application (roughly 30 seconds to a minute). The data collected by the device is stored locally and, preferably, in an internet-based database for analysis. Any particular test value is seen in the context of the larger data set and compared to the statistically derived expected values. Those values would be calculated with respect to the operators own historic performance and the performance of the test-subject's peers in the same or a similar industry.

### BRIEF DESCRIPTION OF THE DRAWING

FIG. 1 is a front view of a commercially available slate-computer showing a display screen and detachable auxiliary equipment in dotted-line illustration;

FIG. 2 is a front view of a commercially available portable tablet showing a display screen and detachable auxiliary equipment in dotted-line illustration;

FIG. 3 illustrates the portable computer shown in FIG. 1 including a representative display for both the physiologic test and cognitive tests;

FIG. 4 illustrates, in a general manner, the software organization of the system shown in FIG. 1 and in FIG. 2;

FIG. 5 illustrates an example display of a test performance index over a period of four days and showing deterioration in test performance;

FIG. 6 illustrates the overall process control flow for initiating operation of the device and execution of the various tests and sub-tests thereof;

FIG. 7 illustrates the process flow of the physiologic part of the overall readiness test;

FIG. 8 illustrates the process flow of the audio part of the physiologic test;

FIG. 9 illustrates the process flow for the audio/video reaction time calculation;

FIG. 10 illustrates the process flow for the movement start time (response time) calculation;

FIG. 11 illustrates the process flow of the movement duration time calculation;

FIG. 12 illustrates the process flow for gaze restoration and the drift time calculation;

FIG. 13 illustrates the process flow of the video part of the overall readiness test;

FIG. 14 illustrates the process flow for the result display routine;

FIG. 15 illustrates the process flow for the image analysis and edge detection routine;

FIG. 16 illustrates the process flow for the cognitive part of the overall readiness test;

FIG. 17 illustrates the process flow for the generalized statistical data analysis routine; and

FIG. 18 illustrates a possible performance index calculation approach.

### DESCRIPTION

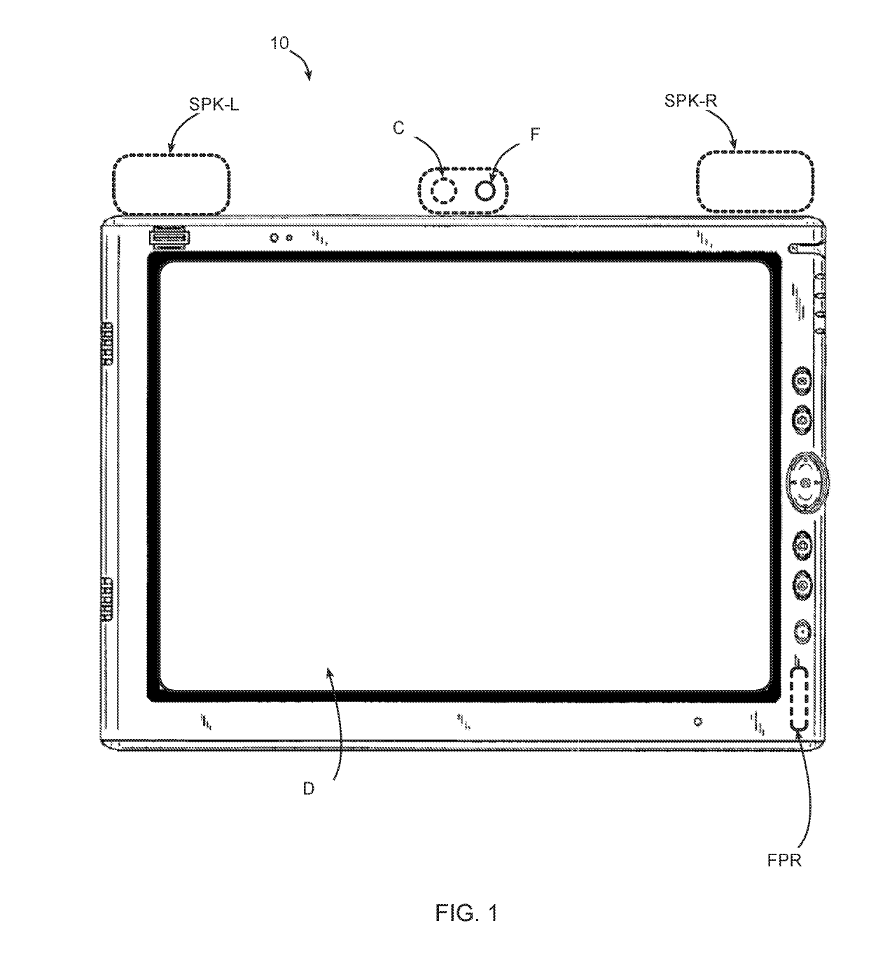

FIG. 1 illustrates an exemplary test device in the form of a commercially available slate-type computer 10 in a portable hand-held configuration (Motion Computing, Austin, Tex.). As shown, the computer 10 includes a touch-input screen display D, an internal microphone (not shown) and, if desired, a finger print reader FPR, by which the test-subject can be biometrically identified. In general, most commercial slate-type computers include internal audio speakers, at least one camera, a microphone, and a flash illumination LED; if need be, external speakers, an external camera, and external flash LED can be attached to the slate-computer 10 as auxiliary attachments including (as shown in dotted-line) left and right speakers SPK-L and SPK-R, a camera C, and a flash illumination LED, The slate-type computer 10 includes a micro-processor, RAM, and a read/write storage device such has a hard drive or a solid-state drive. Additionally, the device also has wired or wireless internet access to at least one remote server.

The computer 10 is programed to execute various programs to display various tests, described in more detail below, and accept input from the test-subject to demonstrate aspects of the autonomic nervous system as well the audio, visual, and motor control pathways. The results of the various tests are stored in the slate-computer 10 memory and/or external database for comparison with prior results for that test-subject and for comparison with a group of peers in that occupation for which the readiness test is designed. The slate-computer can communicate with a local and/or remote server via a wired or wireless internet connection to which current test results are stored and from which historical date is obtained.

In general, the operator-readiness test and the sub-tests thereof, when processed, provide a relative performance level or, possibly (based on the end user discretion) a yes/no answer to the question of operator readiness. The test subject's performance is compared to his/her own historic performance and/or performance of test subjects in the same position (viz., who are part of the same testing protocol). The performance deterioration limits could be set (see FIG. 5), by the end user resulting in some form of corrective action taken: yes/no readiness answer, for example, with denial of access to the work place by those who fail the test. Alternatively, the result could be used as a training, schedule, drug-testing guide, etc.

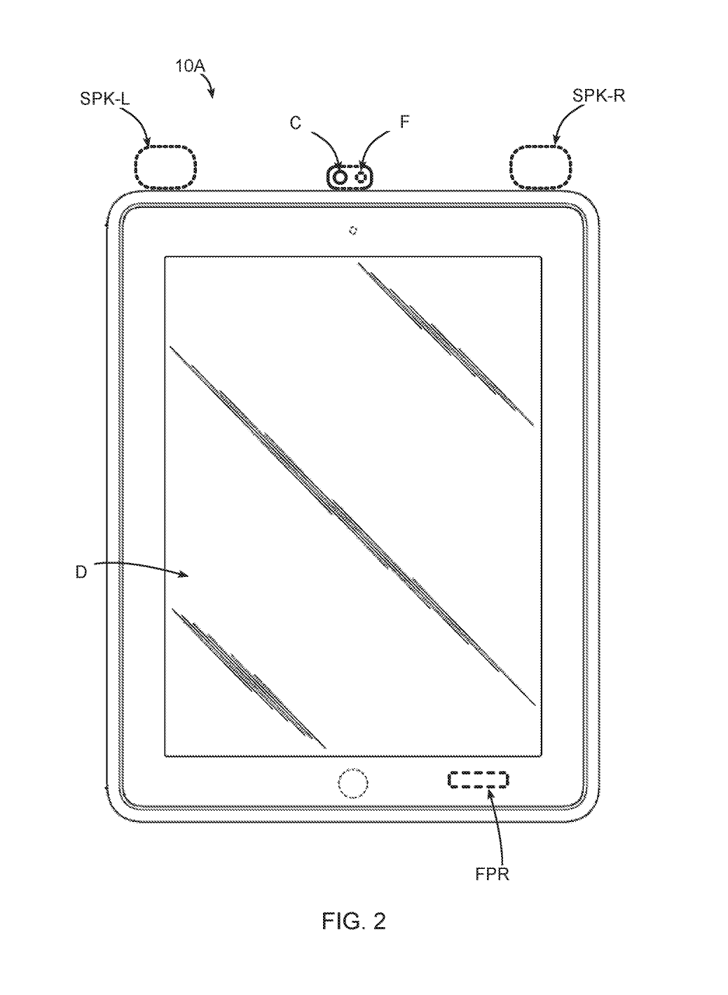

FIG. 2 illustrates an equally suitable test device in the form of a portable tablet 10A (Apple Inc., Cupertino, Calif.); as in the case of the slate-type handheld computer 10 of FIG. 1, auxiliary devices can be connected thereto where necessary or desired.

While portable slate or tablet devices are preferred, the test system can be adapted to laptop or laptop-convertible computers and conventional desktop computers with or without touch-screen capabilities. Alternatively, a custom-built device could implement all the functionality presented above.

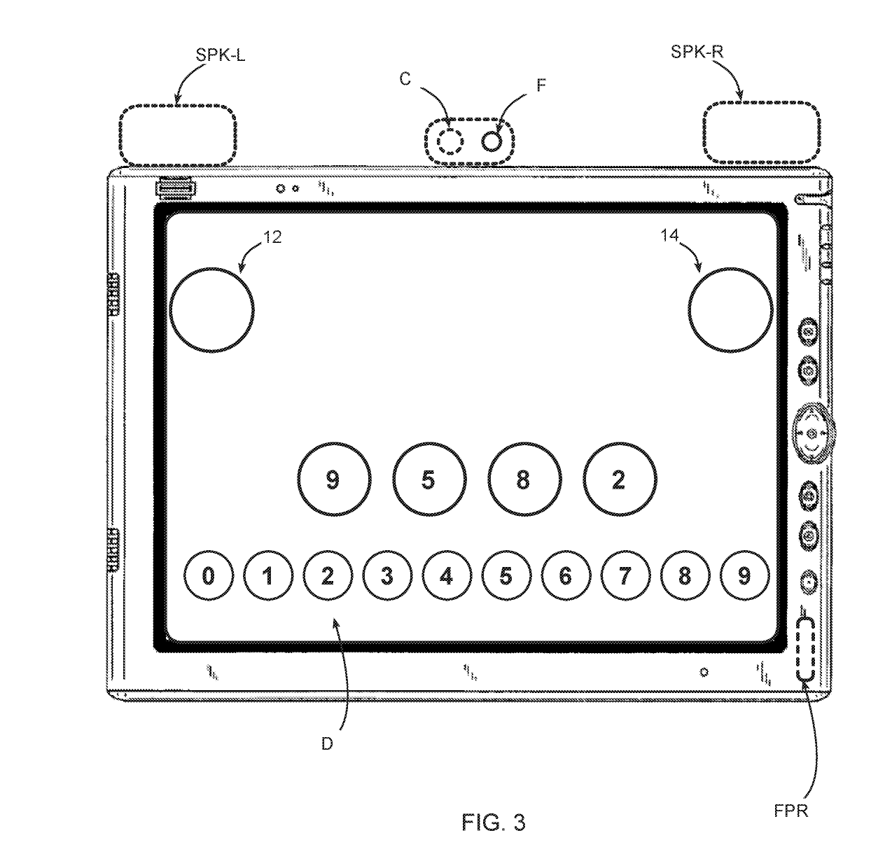

FIG. 3 presents a representative test display for the devices shown in FIG. 1; as shown a circular portion 12 of the screen is provided on the upper left side of the screen and another circular portion 14 on the upper right side of the screen. Each circular screen portion represents a screen area that is momentarily and selectively activated to display a white (or other color) in response to a stored-program controlled processor to define a blinking or flashing light stimulus. While two circular areas are shown in FIG. 3, a plurality of such areas can be used.

The lower portion of the screen displays a set of numerals (i.e., four) with 0-9 numeric touch-responsive “keys” appearing at the bottom of the screen. The test-subject is informed via a text message appearing on the screen or an audio message delivered via the speakers to observe the sequence in which four randomly chosen numerals appear on the display with the requirement that those numbers and characters be inputted into touch-responsive “keys” appearing at the bottom of the screen (or a physical keyboard) in the sequential order in which they appeared on the display. The accuracy of the keypress sequence, the accuracy of the individual character keypresses, the time-to-complete each keypress, and the time-to-complete the test are stored in a database. This test can be repeated n times to create a data set in which the statistical mean can function as a figure-of-merit. Additionally, each successive test can be provided with instructions to complete the task within successively shorter time periods, i.e., 10-seconds, 9-seconds, 8-seconds, 7-seconds, 6-seconds, etc. in order to find the best time-to-completion for that test-subject.

The screen display of FIG. 3, can be used to test the test-subject neuromuscular system as well as audio, visual, and motor-control pathways. For example, the test-subject is provided with an audio message to look at and follow the blinking light pulses appearing in circle portions 12 and 14 as the lights blink on and off alternatively between the left and right positions. The camera C tracks the eye-movement and/or the movement of other facial features of the test-subject as the pupils and/or face moves back-and-fourth between the left and right circular areas 12 and 14 and stores that information in the system memory for analysis and comparison with historical data for that test-subject.

In addition to or in the alternative, the test-subject is provided with audio instruction to turn his gaze to the left or right of the device 10 and return his gaze to the central portion of the screen when a flash is detected from the flash provided by LED F. Upon sensing the flash, the test-subject will then turn his gaze from a position away from the device C to the central portion of the screen with the system camera C measuring the amount of time from the flash to the start of movement of the subject head and the rate of turn of the test-subjects head. The system will also test the ability of the test-subject to return the gaze to the same point determine a “drift” value, which tests the neuromuscular coordination. In all of these tests, the test-subject's responsiveness of the test-subject's neuromuscular system is tested and the results stored in the device internal memory and an external database.

In order to test higher executive function, after audible instruction is provided by the speakers (or earphones), the device 10 quickly displays (or speaks) an arbitrary set of numbers, as shown by the four numbers shown in FIG. 3. The test-subject enters the number into the keypad positions 0-9, or speaks the numeric sequence into the microphone to replicate the order the numbers were initially presented. Another version of the test, which could be administered alone or in conjunction with the previous test version, the circular areas in FIG. 3 light up in a specific sequence which the test-subject replicates either by touching those circles or speaking their sequential number (1 to 4, left to right). Should the test-subject make an error, the test is repeated at a slower speed until the correct answer is obtained (applies to both test variants). The system stores both the speed of entry and the number of attempts in the device database and the external database.

The cognitive performance associated with computation could also be tested, for example, by presenting an arithmetic problem, either in a visual or spoken form, for which the test-subject provides the answer by using the keypad touchscreen or by speaking into the microphone. The variety of executive function tests described above delivered in a visual and/or audio modality test audio-visual-cognitive pathways of the test-subject.

A further test can involve, for example, a randomly generated high-pitch sound on either side of the testing subject who then responds by looking and/or turning towards the source of the sound. In a similar manner, a flashing light can also be used. Multiple rounds of sound and flashing lights are delivered separated by a random pause. The light testing starts with single flashes on either side which, after a random pause, are followed by a series of flashes on either side moving up and down and left to right to interrogate the test-subject's field of view. The sensors in the device will detect and calculate the test-subject's reaction times as well as the reaction time of the test-subject's eye pupils.

After the first part of the test is completed, the lower part of the device presents the executive function test. The executive function test includes the ability to quickly recognize the information presented in terms of the order of appearance of the symbols and the content contained within. Three or four circles display on the screen flash light in a fast sequence and in a random order. After the sequence is completed and after a short pause, the test-subject must touch those circles in the proper sequence. If there is an order-recognition failure, the display will, after a short pause, generate a new random sequence at a slower pace, and so on till the test-subject correctly recognizes the sequence. The second round of tests is comprised of the same circles which would in a random order display random numbers (or some other symbols). The test-subject has to recognize which number (or some other symbol—chosen based on the application) was displayed in which order. This procedure will proceed much the way the previous one did; the symbols are first displayed in a quick succession and if a failure is encountered will repeat the process at a slower pace until the sequence is correctly recognized. This test should take less than a minute even with multiple failures, but considerably less if the successful recognition occurred immediately. The test device will record the failure rates, number of attempts, and the times to successful recognition.

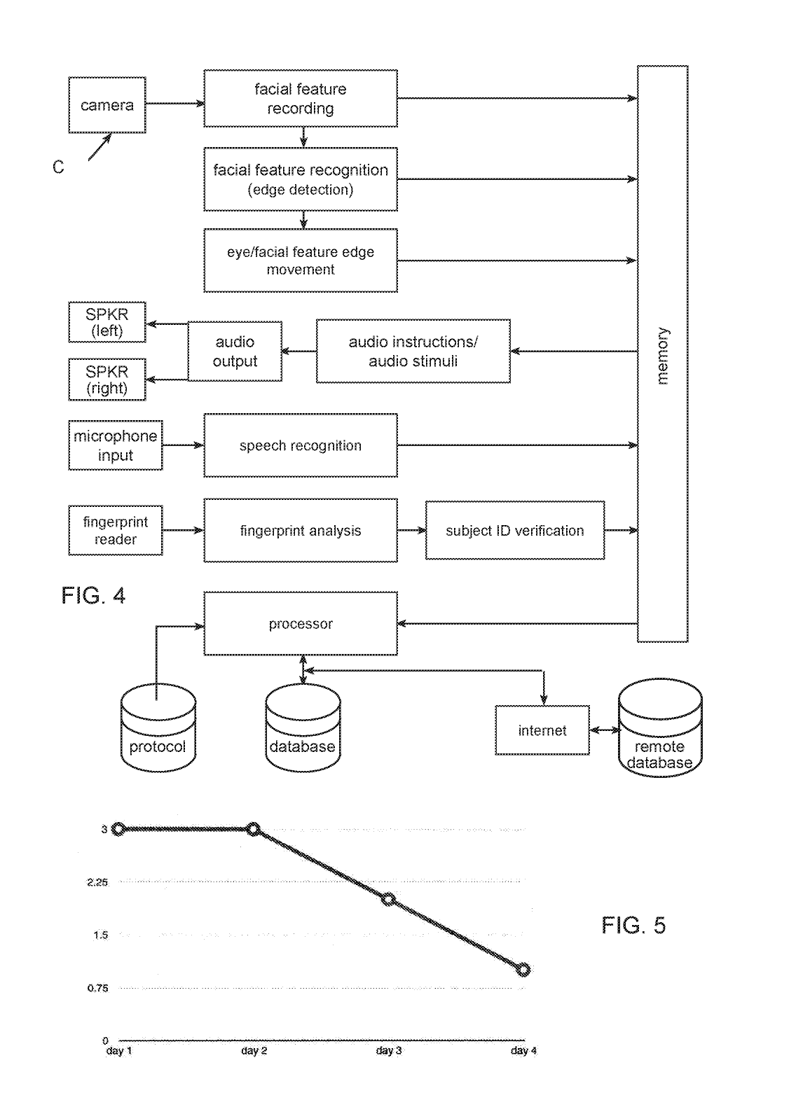

FIG. 4 illustrates software-driven processing pathways for the output of the camera C, the left and right speakers SPK-L and SPK-R, and the microphone. The camera C output is provided to a pupil/eye/facial features tracking pathway which provides quantitative data points related to start and stop times for the pupil to the memory. In a similar manner, the output of the camera C is provided to image analysis/facial recognition software, which preferably uses edge-detection of the facial features, to determine the position of the test-subject gaze. Quantitative data relating to the test-subject gaze is then determined and provided to the memory.

In the case where audio instruction is to be provided to the test-subject, the memory provides the desired audio to the speakers including a channel for the left speaker SPK-L and another channel for the right speaker SPK-R.

In the case where the microphone is to accept spoken input from the test-subject, the microphone is provided to a speech recognition module which is provides the information to a quantitative analytic module to provide word accuracy and start/stop times to the memory.

FIG. 5 represents an example of a run chart for multiple tests over a four-day period which illustrates deterioration in the test-subject performance after the second day.

Once the data is collected it can be analyzed by a wide range of statistical and data analytics tools. In addition to the run charts (FIG. 5), a threshold value can be set (based on the history, experiments, and correlation with an adverse events database) and an alarm or alert triggered when the test-subject falls below the threshold indicating an unsafe performance state.

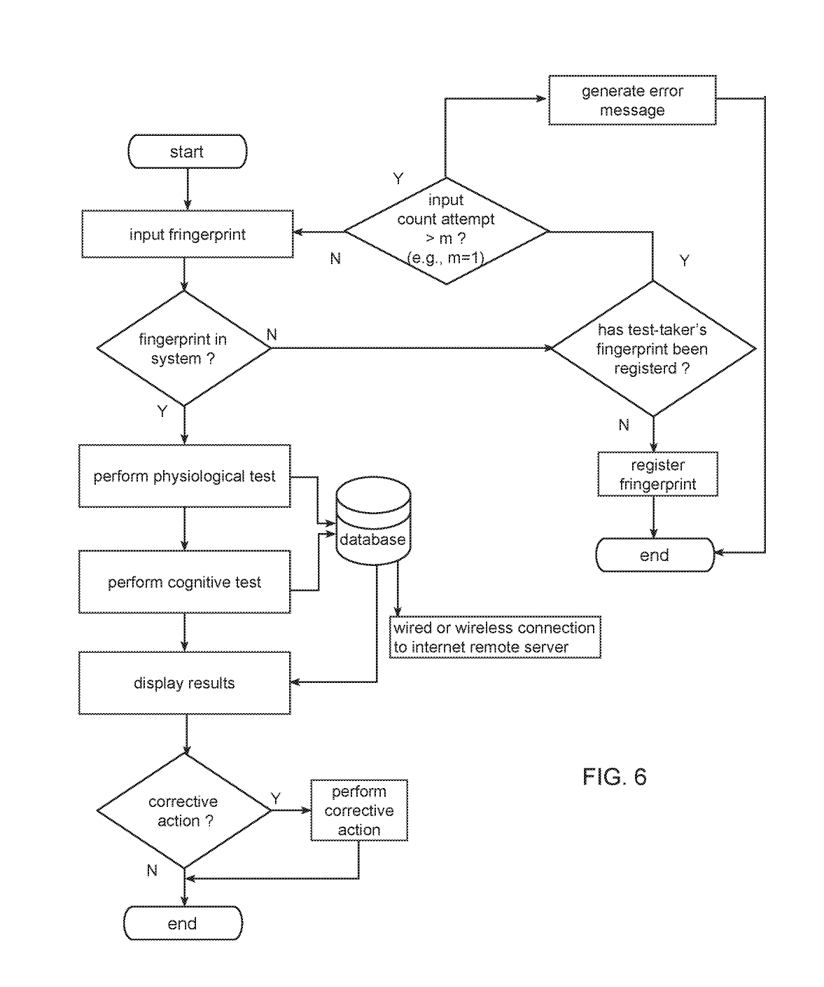

While a number of process flow arrangements are possible, an exemplary process flow system is shown in FIGS. 6-16.

As shown in FIG. 6, the process flow is started and, thereafter, the test-subject inputs their fingerprint into the fingerprint reader FPR. A query is presented as to whether or not the so-inputted fingerprint is in the system (i.e., the fingerprint is already in system memory). If the answer is NO, a query is presented as to whether or not the fingerprint has been registered, and, if NO, the registration process is performed and the program ends with the test-subject potentially locked out of system (if the end user so desires). If YES, the process flow repeats the input-fingerprint step based on the number of attempts (in high security situations, the attempts may be limited to one). Once the fingerprint input identification procedure has been accomplished, the physiologic test and any sub-test thereof are performed with the quantitative data points and values thereof stored in the database, The cognitive test or sub-tests are likewise performed and the quantitative values thereof also stored in the database. The results of the physiologic and cognitive tests are then displayed with the process flow presenting a query as to whether corrective action is required and, if YES, the corrective action is taken, and, if NO, the program ends. As mentioned before, the corrective action is based on the end user's application objectives, which objectives could result in access denial, training, scheduling, drug testing and/or more detailed readiness testing, or some other action.

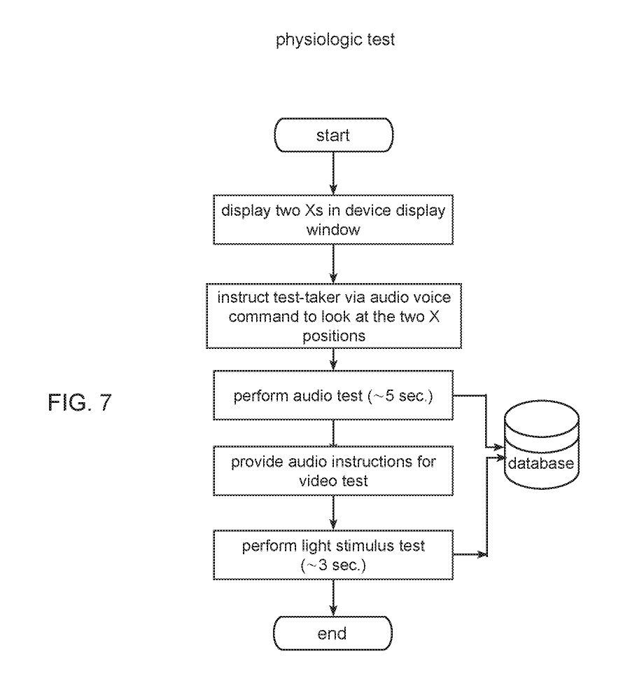

FIG. 7 presents process flow for the physiologic part of the overall readiness testing. The test-subject, after successful log-in (FIG. 6), is instructed in a brief audio instruction to look at two marks (e.g., Xs or circulus or any mark designed to function as a focal point) displayed on the test device. The Xs roughly correspond to the location of the test-subject's gaze. First, the audio test is performed as discussed in preceding paragraph, followed by a brief audio instruction and video test.

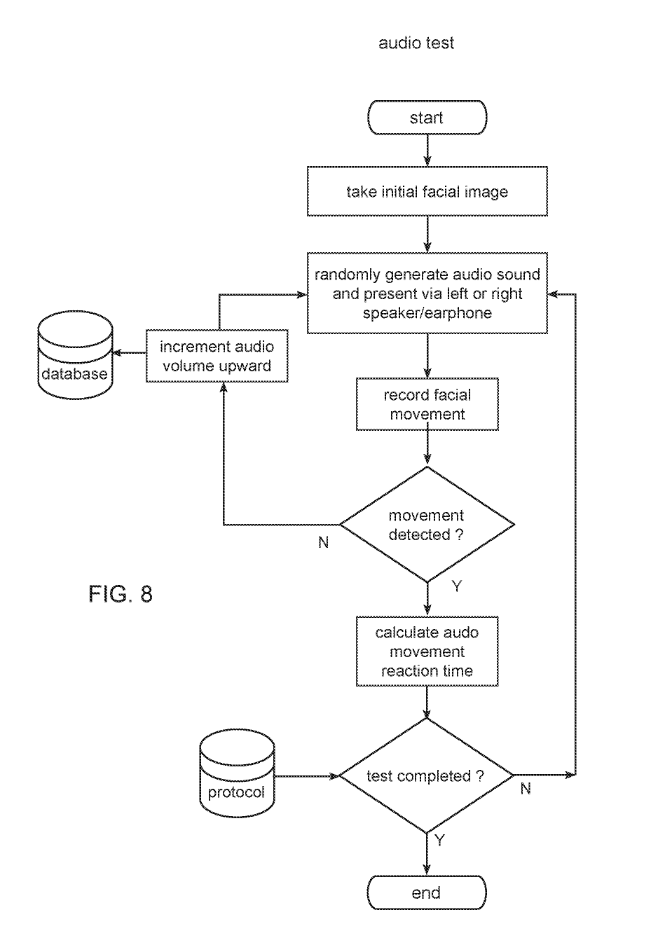

FIG. 8 presents a more detailed view of the audio part of the physiologic test. The initial facial image is taken to be used as a basis for calculation of gaze/face movement and gaze return. The initial sound level in dB is presented at a level intended to not be heard by the test-subject. The sound level is incremental upward until such time that the test-subject hears the sound. That level is recorded in the data base as one of the test parameters. After the response is noted, the time, duration, and return of the gaze to the initial point is calculated. The ability of the test-subject to return their gaze to the initial point is defined here in and calculated as “drift” with the average of all drift calculations for the test defined herein as the “drift parameter”. All the parameters mentioned are saved in both internal (to the device) and external data storage. The test is repeated in accordance to the protocol being exercised; a fixed number combination of left and right stimulations randomly chosen.

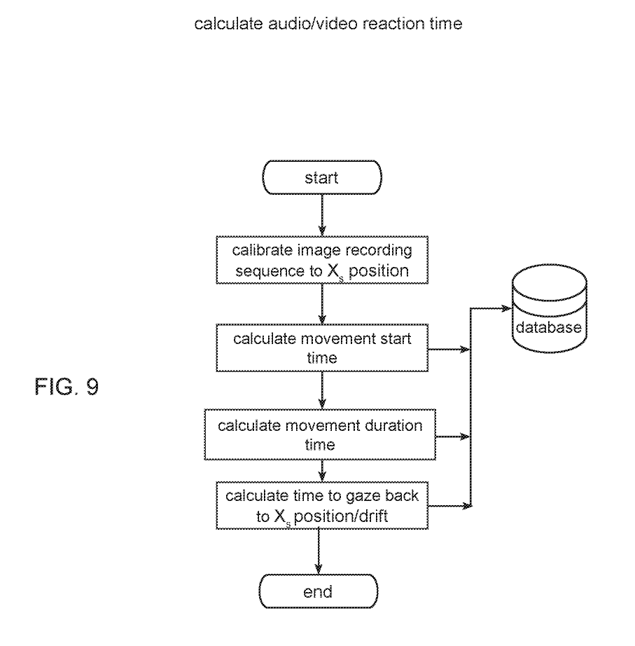

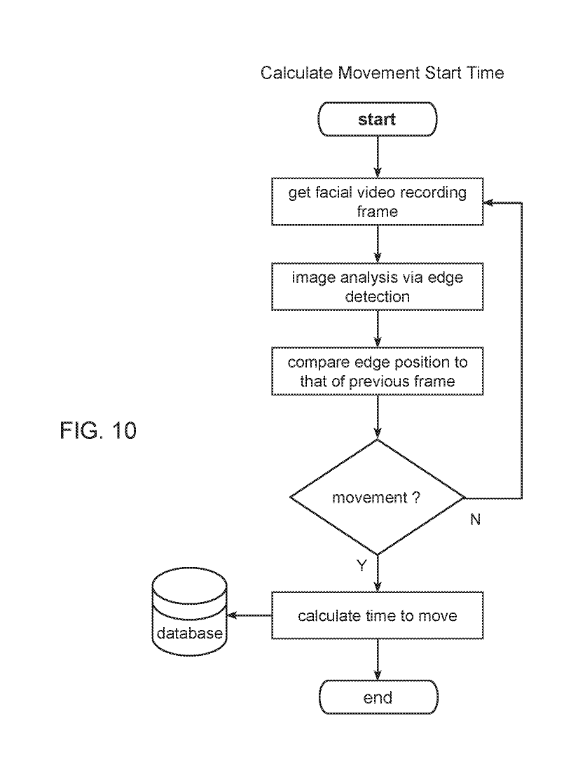

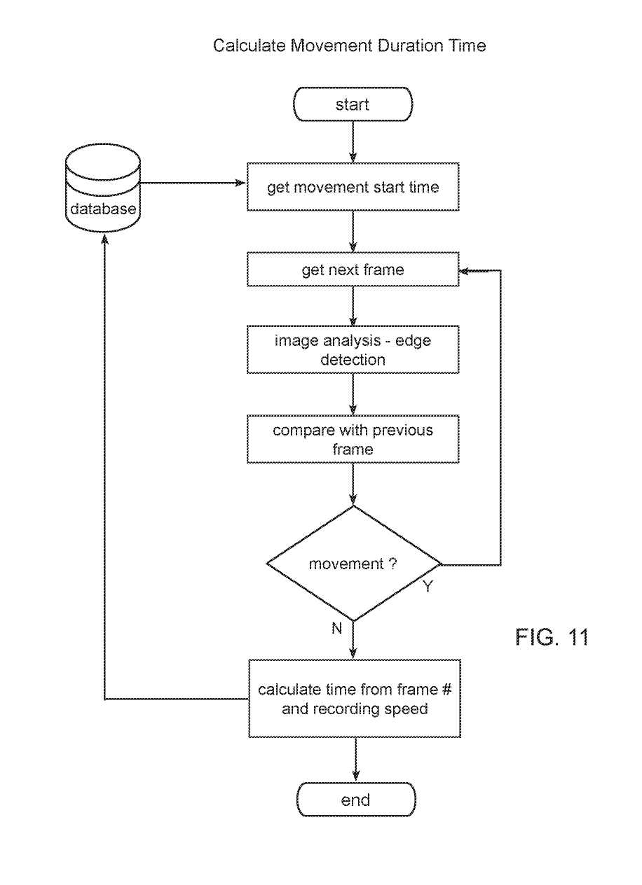

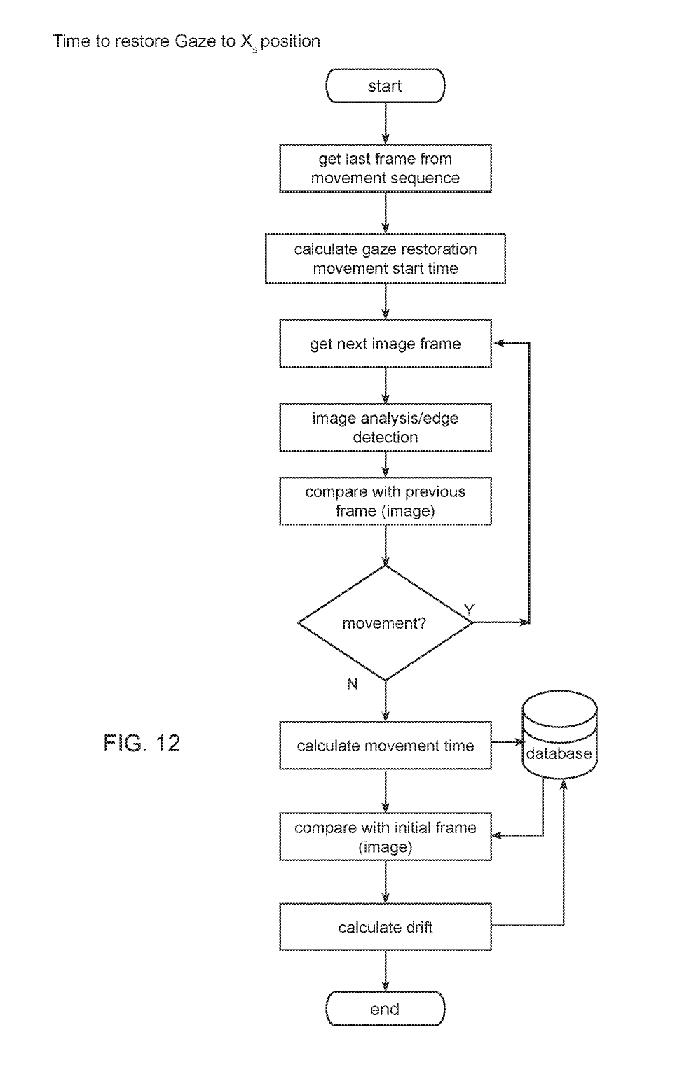

FIG. 9 illustrates the process flow for the calculation of the test-subject's audio/video response time with FIG. 10, FIG. 11, FIG. 12 presenting details of the response time calculation; movement start time, movement duration time, gaze restoration time and drift, respectively. The basic principle applied is continuous video recording of the test-subject's face as the stimulus is generated. The facial features (including eyes, pupils, nasal, mouth and other significant features) are extracted via off-the-shelf image processing/edge detection software.

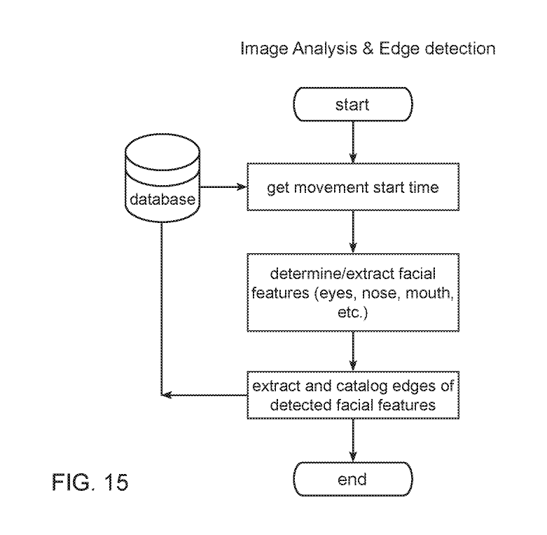

Once the edges and points assigned to those features are mapped for each frame (see FIG. 15), the calculations are performed by counting the frames and comparing the location of the feature points to the initial frame. Knowing the recording speed and the frame count yields the desired time intervals.

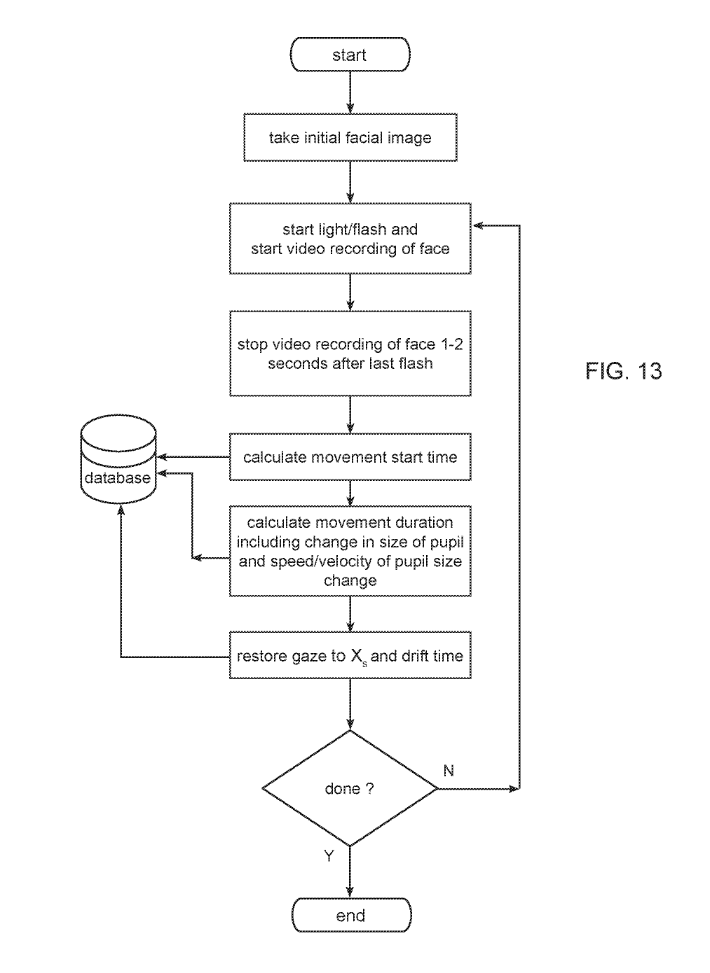

FIG. 13. Illustrates the video part of the physiologic test. As with audio part of the test, the initial facial image is taken to establish a baseline for the drift calculation when the gaze is returned to the initial point. The drift calculation is an important test of the neuromuscular axis often used in impairment testing (akin to finger to nose tip tests in roadside impairment testing). The video tests a video cue in the form of light flashes as generated and as described in the paragraphs above. The subjects face is video recorded just in the way the recording is done in the audio testing of FIG. 8. The light cues are randomly generated in accordance to the test protocol used and may include left, right, center and/or moving light flashes. Multiple response parameters are calculated by the process steps presented in FIGS. 9 to 12. The same facial feature analysis and processing modality is used in this test step as well.

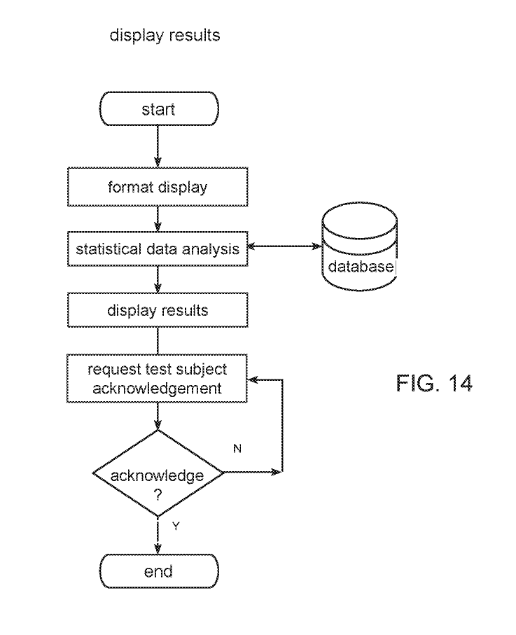

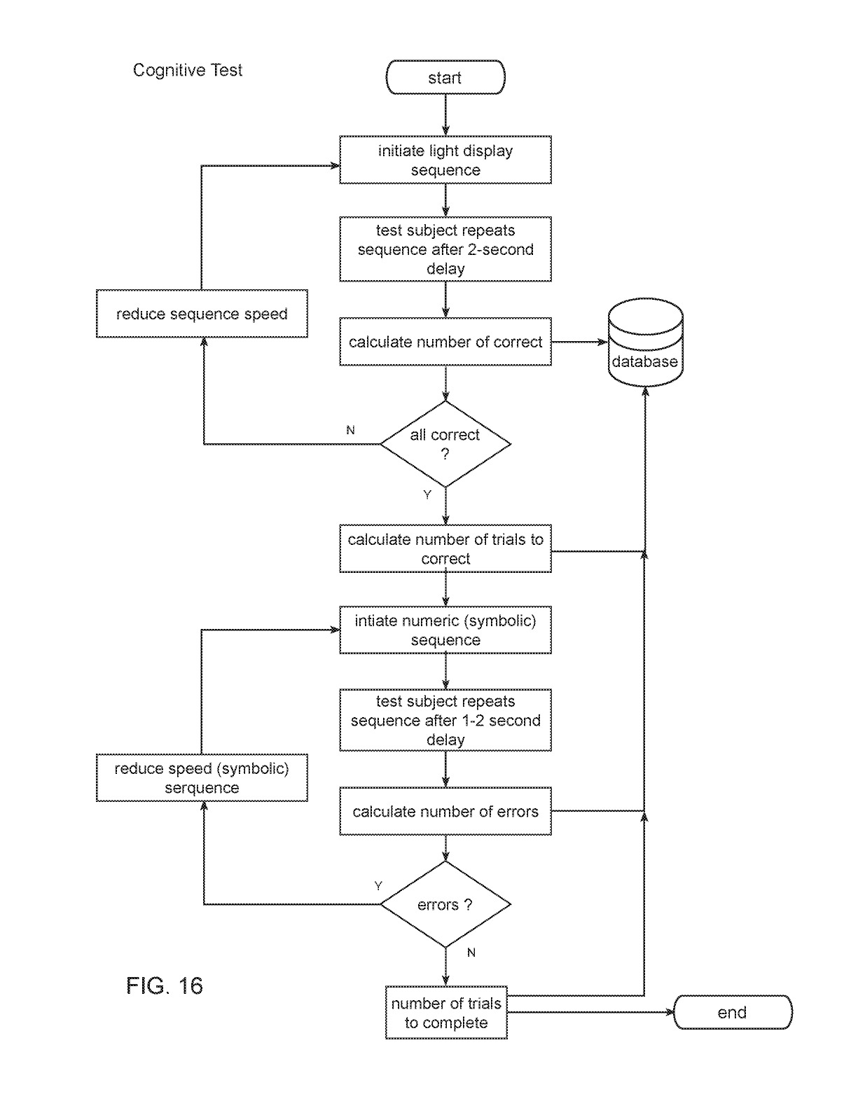

FIG. 14 illustrates the display function. The results can be displayed to the test-subject at the time the test is completed and/or at the management level as a part of performance inquiry. The process presented in FIG. 16 requires that the test-subject acknowledges the result, but result acknowledgment can be omitted if the test protocol requires it.

FIG. 15. Illustrates the image processing/analysis and edge detection process flow. Basically, off the shelf software should be used to analyze the image and detects the edges of the important facial features including eyes, pupils, nose etc. Once the edges and points assigned to those features are mapped the data is stored in the memory for each image of the facial features taken. Those points are compared between consecutive frames to detect movement.

FIG. 16. Illustrates the detailed process flow of the cognitive part of the overall readiness testing. As shown and after the process flows started, the light display sequence is initiated with the test-subject thereafter repeating the test sequence. A calculation is made to determine the number of correct entries; if there is an incorrect entry, the sequence repeats at a reduced speed until such time that all sequence entries are made without error, i.e., all correct. The number of trials that were correct is determined and that information stored in memory. Thereafter, the numeric or symbolic sequences process flow is initiated with the test-subject repeating the sequence after a short delay; if there are errors in the process flow loops at a lower speed until all responses are correct. FIG. 16 demonstrates two tests described in more detail above, but additional tests can be added to follow in sequence. The basic intent of FIG. 16 is to test higher cognitive functions and short term memory. In addition, some neuromuscular performance testing (response time to initiating the answer) is implicit providing a cognitive test as well. The basic methodology is to randomly generate visual and/or numeric sequences which the test-subject is to replicate. Both the duration of the display and the time to respond are fixed by the test protocol. An error in answering the question will result in another sequence of the same type being given but at the lower speed (the image is presented longer) and allowing the test-subject more time to replicate the sequence (longer timeout). The test will continue till the correct answer is obtained or the protocol (based on the end user option) ends the test. The relevant data-response time (how quickly the test-subject starts and how quickly delivers the answer) and number of attempts are recorded in the database (just as the other parameters are).

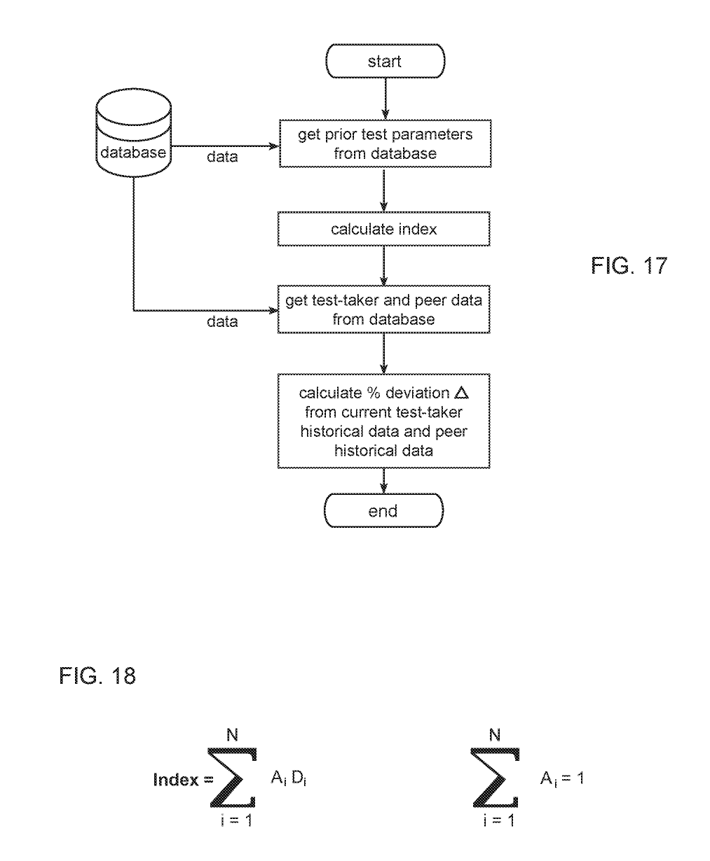

As shown in the FIG. 17, the statistical data analysis can be done in a number of different ways as determined by the end user requirements and needs. However, in all cases, it would involve retrieval of the historic data from the local database or a large distributed database (for a large applications) involving internet based databases in different regions and/or different continents. The historic data would be the data pertaining to the test-subject's previous tests to be compared with the current test. The current test data could be tested against the data of the test-subject's peers and/or test-subjects performing similar activities but following the same protocol.

FIG. 18. Illustrates a possible performance index calculation approach; all performance measures (Di) are multiplied by a weight factor (Ai) and added together. The weight factors are adjusted based on the application and testing experience. The sum of all the weight factors is 1 to keep the performance index in a reasonable numeric range.

As will be apparent to those skilled in the art, various changes and modifications may be made to the illustrated embodiment without departing from the spirit and scope of the invention as determined by the appended claims and their legal equivalent.

1. An operator readiness system, comprising:
a stored-program processor-controlled device having a display screen, one or more audio output devices, a camera for recording images of a test-subject viewing the display screen, and at least one memory device for storing programs to be executed by the processor and data regarding the test subject performance;
subjecting the test-subject to a sequence of tests selected from the group consisting of physiologic tests, cognitive tests and storing the results thereof in the memory device for comparison with the results of prior tests to detect a deterioration in physiologic performance of at least one of the visual, aural, or motor pathways when the selected tests are physiologic tests and to detect a deterioration in cognitive performance when the selected tests are cognitive tests.
